(19) United States
(12) Patent Application Publication
(10) Pub. No.: US 2023/0264988 A1
(43) Pub. Date: Aug. 24, 2023

(54) APPARATUS FOR MEMBRANE FILTRATION AND FOR REMOVAL OF MICROPOLLUTANTS FROM LIQUIDS BY MEANS OF A REACTIVE SUBSTANCE

(71) Applicant: BOSEVO GMBH, Gotha (DE)

(72) Inventors: Andre LERCH, Dresden (DE); Anett WERNER, Dresden (DE); Hardy MÜLLER, Muldenhammer (DE); Kurt BOCK, Erfurt (DE); Eberhard SEMMLER, Blankenhain (DE)

(21) Appl. No.: 18/017,148

(22) PCT Filed: Jul. 15, 2021
(86) PCT No.: PCT/DE2021/200094

§ 371 Date: Jan. 20, 2023

(30) Foreign Application Priority Data
Jul. 21, 2020 (DE) 10 2020 119 204.5

(51) Int. Cl. C02F 1/44; C02F 1/28; B01D 61/14; B01D 61/18; B01D 69/04; B01D 69/06

(52) U.S. Cl. CPC C02F 1/444; C02F 1/283; B01D 61/146; B01D 61/18; B01D 69/04; B01D 69/06; C02F 2103/343

(57) ABSTRACT

The invention relates to a device for membrane filtration and for the removal of micropollutants from liquids by way of a reactive substance, the device comprising a reaction chamber and at least one port for supplying and/or discharging the reactive substance to and/or from the reaction chamber, such that the micropollutants are able to react with the reactive substance in the reaction chamber and/or may be removed from a liquid, and the reaction chamber comprising a first membrane and a second membrane, the first membrane being designed as an inlet into the reaction chamber and the second membrane being designed as an outlet from the reaction chamber, such that the liquid to be treated is able to be filtered by the first membrane and to flow into the reaction chamber, the liquid treated with the reactive substance in the reaction chamber is able to be filtered by the second membrane and to flow out of the reaction chamber, and the outflow of treated liquid is substantially free from micropollutants.

The invention relates to a device for membrane filtration and for the removal of micropollutants from water or other liquids by way of a reactive substance, the device comprising a reaction chamber and at least one port for supplying and/or discharging the reactive substance to and/or from the reaction chamber, such that the micropollutants are able to react with the reactive substance in the reaction chamber or may be removed from the liquid, and the reaction chamber comprising a first membrane and a second membrane.

The removal of micropollutants, such as pharmaceutical residues and/or poorly degradable organic substances, for example, is a major problem in the regeneration or purification of liquids in general, but especially in drinking water, wastewater and industrial water treatment and in the reuse of water. In order to comply with existing and future limits and guide values, various methods are known for removing pollutants and specifically micropollutants. To this end, for example, membrane filtration is combined with reactive processes, on the surfaces of particulate or immobilized solids, for example. Reactive solids, such as absorbers, ion exchangers, catalysts and the like, for example, may be integrated into and/or immobilized in a membrane filter layer itself or in the permeate chamber of the membrane system.

For example, WO 2015/165988 A1 describes a filter element for a liquid filter in which a nonwoven filter is arranged as a drainage element in a laminated manner between two filter membranes by way of a nonwoven adhesive fabric. Reactive material such as adsorbents and ion exchangers may be incorporated and fixed in the nonwoven filter. A disadvantage here is that it is not possible to achieve an adequate flow to the loaded reactive material in the nonwoven filter, such that is not readily available for an efficient regeneration.

DE 10 2018 009 597 A1 discloses a device for repeatedly changing the composition of a fluid, said device comprising a first filter module followed by a retention module with plates and a second filter module. The fluid to be treated enters the first filter module via an inlet in the retentate channel, the first filter medium in said module serving only to introduce supply medium into the retentate channel and the second filter medium in said module bringing about a selective separation effect in which only certain constituents of the fluid are able to pass through the second filter medium. The main stream of the fluid is supplied directly to the retention module. The second filter module, downstream of the retention time module, serves to hold back a vaccine contained in the fluid as a product by way of the second filter medium in the second filter module, while the contaminants are able to pass through it.

A disadvantage of immobilized reactive solids is that they are consumed and/or exhausted over the operating period, such that the removal of micropollutants decreases as the operating period increases. Moreover, a regeneration of the properties of the reactive solids in situ in the immobilized state is either not economically possible or is possible only to a limited extent.

As a general rule, a regeneration of a reactive substance in a membrane system is possible only with a great deal of effort and high costs. In some methods, such as the membrane bioreactor process, for example, in which the reactive substance is introduced directly into the biological activation stage, a regeneration of the reactive substance in situ is possible only with very great difficulty, since it is covered with bacteria.

If an in-situ regeneration of a reactive substance within a membrane system is possible at all, the regeneration processes cannot be repeated at will, because the regeneration processes may damage the long-term stability of the membrane system. Thus, for some reactive substances the regeneration has to be carried out at very high temperatures, which the membrane used in the membrane system is unable to tolerate, causing it to be damaged.

In principle, a membrane system as a first treatment stage may also be followed by a removal of micropollutants as a downstream treatment stage. To this end, for example, the membrane filtration may be followed by an activated carbon adsorption column, through which the permeate from the membrane filtration is passed. Disadvantages here, however, are the complex, multi-stage process, the larger size due to the separate treatment stages, and the need to coordinate the processes used in the individual treatment stages.

The object of the invention is to improve the prior art.

The object is achieved by a device for membrane filtration and for the removal of micropollutants from liquids by way of a reactive substance, the device comprising a reaction chamber and at least one port for supplying and/or discharging the reactive substance to and/or from the reaction chamber, such that the micropollutants are able to react with the reactive substance in the reaction chamber and/or may be removed from a liquid, and the reaction chamber comprising a first membrane and a second membrane, the first membrane being designed as an inlet into the reaction chamber and the second membrane being designed as an outlet from the reaction chamber, such that the liquid to be treated is able to be filtered by the first membrane and to flow into the reaction chamber, the liquid treated with the reactive substance in the reaction chamber is able to be filtered by the second membrane and to flow out of the reaction chamber, and the outflow of treated liquid is substantially free from micropollutants.

The device thus allows for a removal of micropollutants from contaminated liquids or dirty water in a reaction chamber by way of a reactive substance, specifically a fluid reactive substance, the reaction chamber being formed between a first membrane and a second membrane. It is particularly advantageous for the first membrane to be designed as an inlet and hence intake for the untreated liquid containing the micropollutants into the reaction chamber, resulting in a prefiltration of the untreated liquid, after which the micropollutants react with the reactive substance or substances in the reaction chamber and/or are removed from the prefiltered untreated liquid.

The reactive substance or reactive substances preferably flow through the separate reaction chamber between the two membranes (optionally microfiltration, ultrafiltration or nanofiltration membranes with an appropriate pore size/selectivity), such that the reactive substance or reactive substances may be continuously replaced and/or continuously removed together with the reaction products that are formed. This allows for an in-situ regeneration at the same time.

Therefore, a single-stage device is provided as a combination of a membrane system with a treatment step by way of a reactive substance, said device permitting a constant renewal of the reactive substance and/or a discharge of the reaction product formed between the micropollutants and the reactive substance. To this end, the separate, delimited reaction chamber has at least one separate hydraulic port to the outside, to enable the reactive substances and/or the reaction products to be supplied to and/or discharged from the membranes separately from the feed and permeate. The separate reaction chamber preferably has two ports to allow for a continuous flow through the reaction chamber along with a loading and/or unloading of fresh and/or consumed reactive substance into and/or out of the reaction chamber.

A single-stage, modular membrane filtration system with integrated treatment of micropollutants by way of a reactive substance is thus provided.

A key concept of the invention is based on the fact that the device is designed as a compact two-stage membrane filtration system with an integrated, intermediate physical and/or chemical reaction chamber, allowing for a continuous or discontinuous loading and/or unloading of the reaction chamber. Since the two filter membranes directly form the inlet and outlet of the reaction chamber, the device constitutes a compact, sole treatment stage.

The following terms are explained:

“Membrane filtration” is understood to mean a mechanical separation and/or purification of substances by filtration through a membrane or a plurality of membranes. The phase held back by the membrane is usually referred to as the retentate and the phase passing through the membrane as the permeate.

The term “liquid” refers in particular to material in the liquid state of aggregation. The liquid may be, for example, an inorganic and/or organic liquid, fruit juice and/or water.

A “micropollutant” (also known as “microcontaminant”) is in particular an unwanted substance in a liquid. A micropollutant is in particular a microscopically small substance which is present in particular in a concentration of nanograms up to a few micrograms per liter of liquid. Micropollutants are, for example, pharmaceutical residues, biocides, household chemicals and other substances used in trade and industry. Micropollutants include in particular a number of different substance groups, such as for example plant protection products, polycyclic aromatic hydrocarbons, organic chlorine compounds, plasticizers, and many other synthetic chemical compounds.

A “reactive substance” is in particular a substance which enters into a chemical and/or physical reaction with a micropollutant or a plurality of micropollutants. This reaction may lead to the formation of reaction products. A reactive substance serves in particular to remove micropollutants from the liquid. In principle, the reactive substance or plurality of reactive substances may be in any state of aggregation, such as solid, liquid and/or gaseous. A gaseous reactive substance may give rise to a flocculation and hence coagulation of the micropollutants, due to an oxidation reaction with the micropollutants, for example. The reactive substances are preferably a dissolved and/or solid substance. The type of reactive substance, such as oxidant, adsorbent and/or ion exchanger, for example, determines the nature of the reaction of the reactive substance with the micropollutants, and hence the nature of the removal. Thus, the reaction of the reactive substances with the micropollutants may be, for example, an oxidation, adsorption, precipitation, coagulation, flocculation, ion-exchange and/or catalytic reaction. The reactive substance may likewise also be a biogenic substance, such as enzymes produced by fungal and/or bacterial culture or a biotechnological product, for example.

The “reaction chamber” is in particular a chamber in which the micropollutants react with the reactive substance or reactive substances and/or are removed from the liquid. The reaction chamber is spatially delimited in particular by the first membrane and the second membrane. In addition, the reactive chamber is connected to a port for supplying the reactive substance to the reaction chamber and/or to a port for discharging the reactive substance from the reaction chamber, or it is spatially limited thereby. The reaction chamber is thus in particular a kind of container, two container walls preferably being formed by the first membrane and the second membrane.

A “membrane” is in particular a flat, semipermeable entity and thus has structures that are permeable at least for one component and/or substance of a liquid coming into contact with the membrane and conversely are impermeable for other components and/or substances. A membrane may be a porous or non-porous membrane. Membranes differ in particular in pore size or in the molar mass of the largest components still able to pass through, in the separating principle, selectivity, filtration pressure and/or other properties. A membrane may contain, in particular, a polymer and/or ceramic.

A “membrane module” (or “module” for short) is understood to be a membrane arrangement to which and/or through which a flow is continuously supplied. A membrane module has at least one inlet or entrance for the liquid to be separated (“feed”) and an exit and hence outlet for the components that pass through and hence for the treated liquid (“permeate”). The membrane module may in addition also have an exit for the retained components (“retentate” or “concentrate”). A plurality of identical modules may in particular be connected in series and/or in parallel.

“Substantially free from micropollutants” is understood to mean in particular that the concentration of micropollutants in the treated liquid must be very low, although it does not have to be zero; rather, it may also be above the detection limit of the analytical method used for the micropollutant in question, for example. For example, the outflow of treated liquid may not be completely free from micropollutants but only substantially free from micropollutants, because a small amount of micropollutants may still pass through the membrane due to membrane slippage, membrane fouling, membrane aging and/or membrane breakdown, despite the designated membrane retention, and may thus be present in the treated liquid.

In a further embodiment of the device, the second membrane has a smaller pore size than the first membrane, such that the reactive substance may be retained in the reaction chamber.

The loaded and/or consumed reactive substance thus remains inside the reaction chamber, while the liquid to be treated flows through the first membrane into the reaction chamber and the purified, treated liquid flows through the second membrane out of the reaction chamber. The retention times of the liquid and of the reactive substance in the device are thus independent of one another.

The nature of the first membrane and the second membrane and hence their respective properties, such as pore size, cut and/or material, for example ceramic membrane or polymeric membrane, are chosen according to the properties of the micropollutants to be removed and of the reactive substances used and according to the untreated liquid quality. The first membrane preferably has a larger pore size than the second membrane, thereby guaranteeing contact between the reactive substances and substantially particle-free untreated liquid, such that the reaction of the reactive substances in the reaction chamber takes place specifically with the micropollutants. Reverse cases are also possible, however, where the fine filtration has to take place first, while the reactants provided for the reaction are more coarsely structured and thus require only a more coarsely-pored second membrane.

The pore size of the first membrane is preferably chosen such that the untreated liquid flows into the reaction chamber at a pressure of approximately 2-8 bar. By contrast, the second membrane has a smaller pore size than the first membrane, for example in the case of an ultrafiltration membrane a pore size of less than the diameter of the reactive substances, corresponding to a molecular mass of approximately 10-30 kDa. An escape of the reactive substances through the second membrane into the permeate, and hence a loss of reactive substances, is prevented in this way, and the retention of the reactive substances in the reaction chamber thus allows for a recirculation and selective regeneration.

The “pore size” of the membrane is understood to be in particular the nominal pore size, which describes the maximum in the pore size distribution. In particular, however, the pore size does not provide a defined statement of the retention capacity of the membrane. That is indicated in particular by the exclusion limit (or cut-off) of the membrane, which defines the lowest molecular mass of a regular molecule that is 90% retained by the membrane. In particular, the pore size of the membrane may range from <1 nm to ≤10 μm.

Under this condition for pore size classification, microfiltration, ultrafiltration and nanofiltration membrane types may be considered suitable in principle.

In order to directly form a wall of the reaction chamber and hence, respectively, the inlet into the reaction chamber for the liquid to be treated and the outlet from the reaction chamber for the treated liquid, the first membrane is arranged on one side of the reaction chamber and the second membrane is arranged on a side of the reaction chamber opposite that side.

The first membrane and/or the second membrane preferably take up all or part of the area of one side and/or wall of the reaction chamber. It is particularly advantageous for the first membrane and the second membrane to directly form walls, in particular opposite walls, of the reaction chamber, such that a simple construction and compact size are achievable. In addition, in the case of a rectangular reaction chamber, for example, the ports for supplying and/or discharging the reactive substance to and/or from the reaction chamber may be arranged opposite one another on the other two walls of the reaction chamber.

In this case, the first membrane and/or the second membrane may be held by way of appropriate support materials for a compact double-membrane structure and to form the reaction chamber that is arranged between them. The reaction chamber may preferably be formed from multiple layers, using textile material, for example, or other open-pored, readily permeable materials.

In a further embodiment of the device, the device is set up in such a way that a flow direction of the reactive substances is substantially at right angles to an inflow and/or outflow direction of the liquid through the first and/or second membrane.

Thus, the flow of the untreated liquid in through the first membrane and the flow of the treated liquid out through the second membrane on the opposite side from the first membrane may take place in the same direction. For example, in the case of a rectangular reaction chamber, the inflow and outflow of the reactive substances takes place at right angles to the inflow and outflow direction of the liquid through the membranes on the other two opposite sides of the rectangular reaction chamber. With appropriate flow control and operating settings, it is possible in this way to prevent an outflow of the reactive substances against the inflow direction into the untreated liquid. It is particularly advantageous here for the diffusion stream of the reactive substances to be smaller than the convection stream of the liquid to be treated. In addition, by optimizing the size and/or particle size of the reactive substances and of the reaction products that are formed, the occurrence of flow defects may also be prevented or excluded.

“Substantially at right angles” is understood to mean in particular that a flow direction of the reactive substance is not necessarily oriented precisely at an angle of 90° to an inflow and/or outflow direction of the liquid through the first and/or second membrane, but rather that the angle of the flow direction may also be greater or less than 90° relative to the inflow and/or outflow direction of the liquid.

For an optimal design of the device as a module with an integrated reaction chamber, the first membrane and/or the second membrane is or are a submerged membrane, in particular a flat-sheet membrane, a spiral-wound membrane, and/or a pressurized tubular membrane.

In principle, it has been found that the first membrane and the second membrane may be of any design, such as a flat-sheet membrane, cushion membrane, tubular membrane, capillary membrane and/or spiral-wound membrane, for example. Thus, in addition to a planar arrangement of the first and second membrane, in a parallel flat-sheet design, for example, a spiral-wound design is also possible. Owing to the pressure ratios, it may be advantageous for the first membrane and the second membrane to be arranged as double membrane envelopes wound in a pressurized tube and/or pressurized tubular module, for example. Likewise, multistage membranes, each consisting of the first membrane and the second membrane, may be arranged in a tubular or capillary module configuration in a pressurized module and/or pressurized reactor.

In a further embodiment of the device, the first membrane and/or the second membrane is or are a microfiltration membrane, an ultrafiltration membrane and/or a nanofiltration membrane.

A “microfiltration membrane” is in particular a membrane having a pore size of >0.1 μm. In particular, a microfiltration membrane separates out a molecule size of >500 kDa, such as bacteria, yeasts and/or particles, for example. In the case of a microfiltration membrane, a transmembrane pressure of in particular <2 bar is used.

An “ultrafiltration membrane” is in particular a membrane having a pore size ranging from 2 nm to 100 nm. In particular, an ultrafiltration membrane separates out a molecular mass ranging from 5 kDa to 5,000 kDa, such as macromolecules and/or proteins, for example. In the case of an ultrafiltration membrane, a transmembrane pressure of in particular 1 to 10 bar is used.

A “nanofiltration membrane” is in particular a membrane having a pore size ranging from 1 nm to 2 nm. In particular, a nanofiltration membrane separates out a molecule size from 0.1 kDa to 5 kDa, such as viruses and divalent ions, for example. In the case of a nanofiltration membrane, a transmembrane pressure ranging in particular from 3 to 20 bar is used.

For an optimal transport and/or mass transfer, the reaction chamber is designed and/or is operable as a batch reactor and/or as a continuous-flow reactor.

If the reaction chamber is designed as a batch reactor, following a one-time loading of the reaction chamber with reactive substance through the port, the reactive substance and the reaction products that form are then circulated through the reaction chamber where almost complete mixing is achieved, or a complete mixing in the reaction chamber is achieved by way of an agitator, so the concentration of the micropollutants and of the reaction products formed changes inside the reaction chamber over time. The reaction chamber may also be designed as a continuous-flow reactor, with a continuous inward flow of reactive substance and outward flow of reactive substance and/or reaction products formed, so concentrations are approximately constant over time. To this end, the reaction chamber has in particular two ports for the supply and discharge of the reactive substances and hence for a continuous flow through the reaction chamber. Therefore, with a continuous flow, the reactive substances that are consumed may, accordingly, be continuously replaced, and likewise the reaction products that form may be continuously removed and sent for regeneration and/or further processing.

In a further embodiment of the device, the device has a regeneration unit for regenerating consumed reactive substance or the regeneration unit is associated with the device.

Thus, in the case of a recirculation system as a batch reactor and/or as a continuous-flow reactor, an in-situ regeneration of the reactive substances may be achieved by way of a regeneration unit. A regeneration of the reactive substances contained in the separate reaction chamber may thus be achieved in a simple manner and at low cost. In the case of a closed recirculation of the liquid and especially of water in the reaction chamber, the reactive substances may be regenerated by UV irradiation, for example.

A “regeneration unit” is in particular a unit which allows the loaded and/or consumed reactive substance to be restored and/or reused after the reaction with the micropollutants. To restore the function of the reactive substance, the regeneration unit may use irradiation, chemical oxidation, temperature change, ion exchange and/or another chemical and/or physical reaction, for example. If the reactive substance is loaded, the loaded surface of the reactive substance is returned to an unloaded surface state by desorption, for example.

In order to retain the reactive substance inside the reaction chamber and/or to reuse it directly, the device contains a reactive substance or a plurality of reactive substances, the reactive substance or plurality of reactive substances being a dissolved, emulsified, dispersed, suspended and/or solid substance.

In a further embodiment of the device, the reactive substance or reactive substances is or are an oxidant, absorbent, precipitant, coagulant, flocculant, ion exchanger, catalyst and/or biogenic substance.

The invention is described in more detail below by reference to an exemplary embodiment. In the drawings:

FIG. 1 shows a highly schematic representation of a basic principle of a membrane-reactive device,

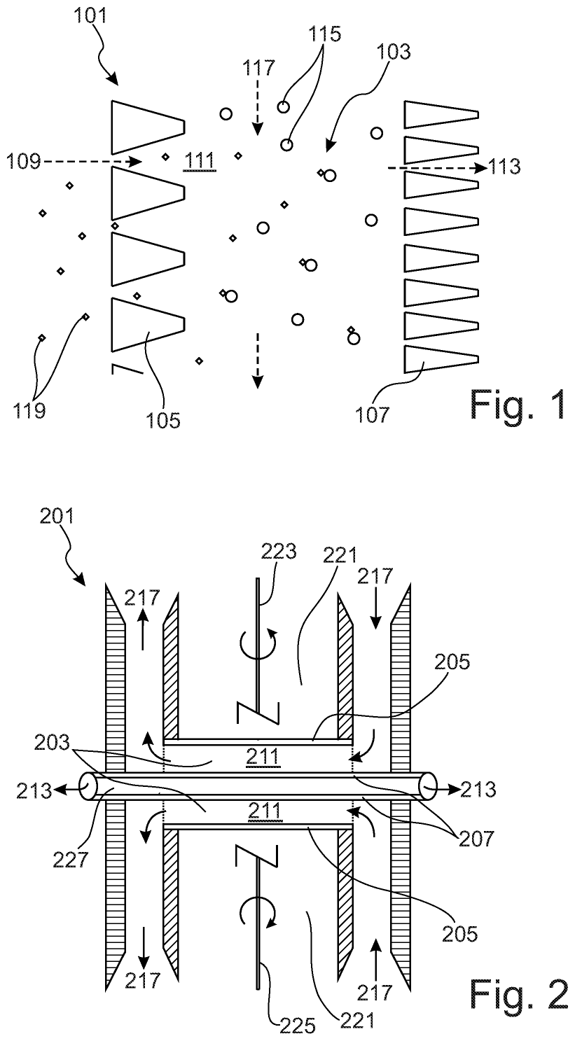

FIG. 2 shows a highly schematic sectional representation of a detail of an embodiment of the membrane-reactive device,

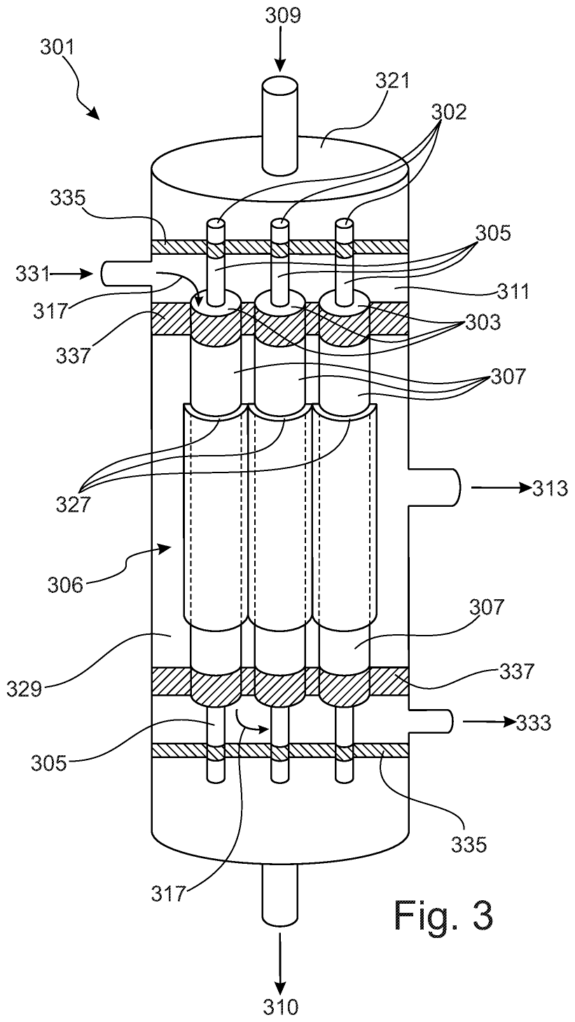

FIG. 3 shows a highly schematic three-dimensional representation of a membrane-reactive modular tubular reactor,

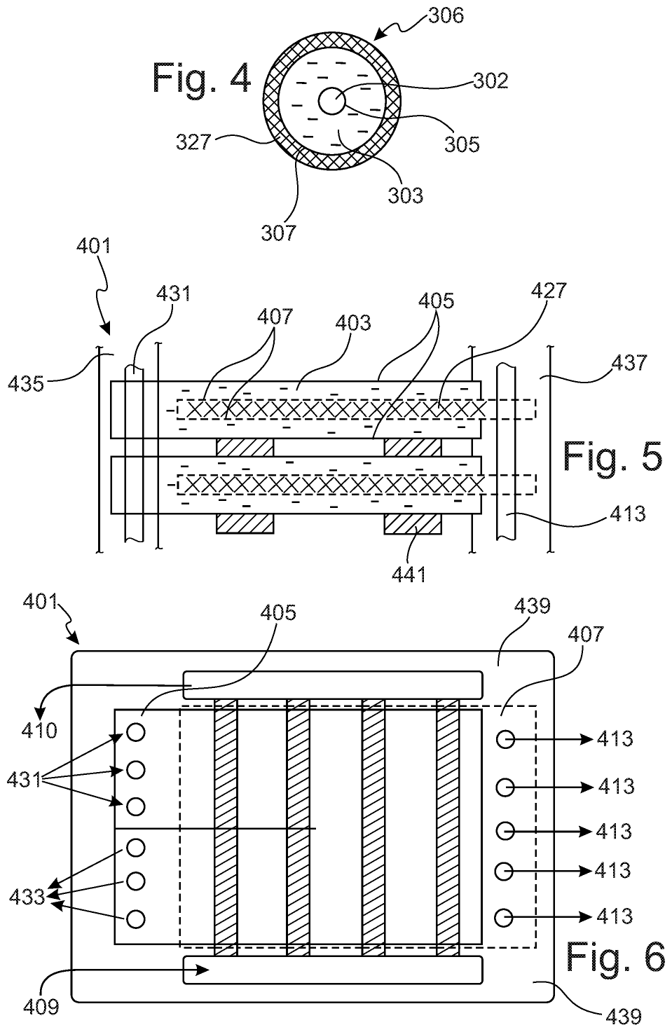

FIG. 4 shows a cross-section through a tubular element of the membrane-reactive modular tubular reactor from FIG. 3,

FIG. 5 shows a vertical section through a membrane-reactive parallel flat-sheet module as a detail,

FIG. 6 shows a section through the membrane-reactive parallel flat-sheet module in plan view,

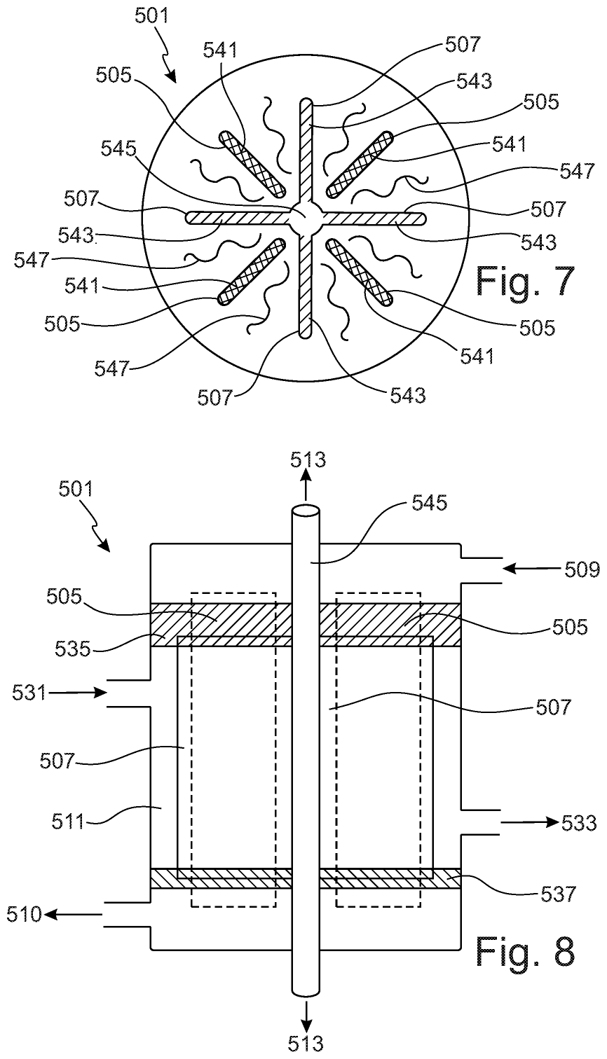

FIG. 7 shows a highly schematic cross-section through a membrane-reactive spiral-wound module in the unwound state,

FIG. 8 shows a highly schematic vertical sectional representation of the membrane-reactive spiral-wound module in the unwound state,

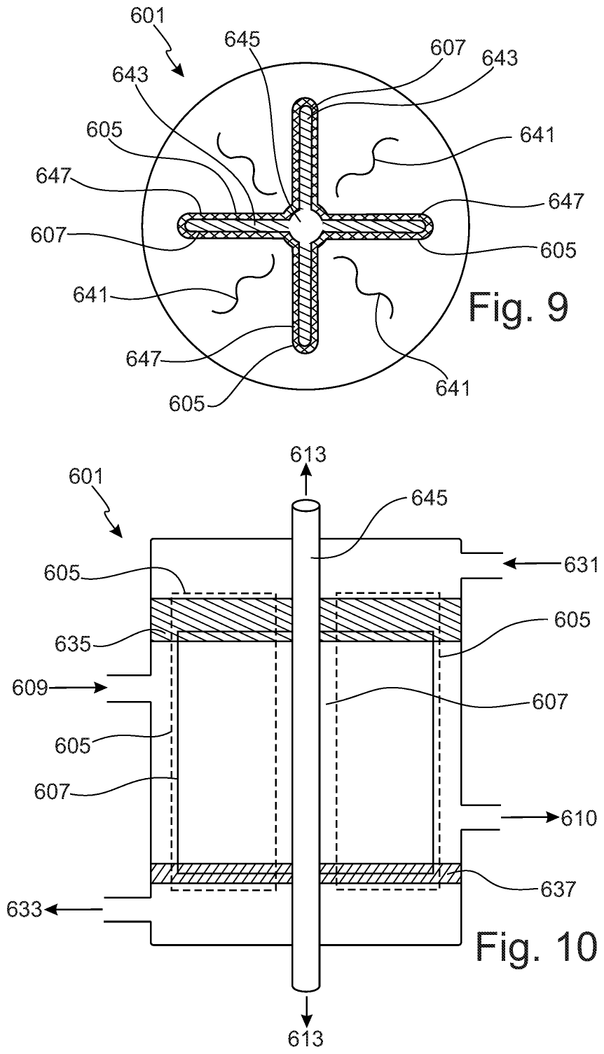

FIG. 9 shows a highly schematic cross-section through an alternative membrane-reactive spiral-wound module in the unwound state, and

FIG. 10 shows a highly schematic vertical sectional representation of the alternative membrane-reactive spiral-wound module in the unwound state.

A membrane-reactive device 101 has a coarse-pore UF membrane 105 and a fine-pore UF membrane 107. A reaction chamber 103 is formed between the coarse-pore UF membrane 105 and the fine-pore UF membrane 107. An untreated liquid stream 109 containing micropollutants 119 enters the reaction chamber 103 through the coarse-pore UF membrane 105 at a differential pressure of approximately 1 bar transmembrane pressure, particulate substances (not shown) being held back by the coarse-pore UF membrane 105 such that a prefiltered untreated liquid 111 is present in the reaction chamber 103. A pore size of the coarse-pore UF membrane 105 is chosen such that the micropollutants 119, which are inter alia pharmaceutical residues, pass through the coarse-pore UF membrane 105 and enter the reaction chamber 103 (see FIG. 1).

Oriented at right angles to the untreated liquid stream 109 is a flow direction 117 of reactive substances 115 which were introduced into the reaction chamber 103 via a port not shown in FIG. 1 and are circulated through the reaction chamber 103 in the flow direction 117 by a pump (not shown). The reactive substances 115 are ultra-fine powdered activated carbon particles on which the micropollutants 119 are adsorbed. The continuous untreated liquid stream 109 causes the treated liquid in the reaction chamber 103 at a pressure of approximately 6 bar transmembrane pressure across the fine-pore UF membrane 107 to be continuously pushed through this fine-pore UF membrane 107 and thus to be filtered more finely, such that a filtrate stream 113 emerges from the fine-pore UV membrane 107. Owing to the oppositely arranged coarse-pore UF membrane 105 and fine-pore UF membrane 107 of the reaction chamber 103, the untreated liquid stream 109 and the filtrate stream 113 are oriented in the same direction, while the flow direction 117 of the reactive substances 115 is oriented at right angles to the untreated water stream 109 and the filtrate stream 113.

In one of a number of possible embodiments, a membrane-reactive device 201 is designed as a double-membrane structure. Here, a fine-pore UF membrane 207 in tubular form, from both ends of which a permeate stream 213 emerges from a second drain 227 (permeate chamber), is surrounded by a flat coarse-pore UF membrane 205. The reaction chamber is embodied as a first drain 203 between the coarse-pore UF membrane 205 and the fine-pore UF membrane 207. The untreated liquid 211 prefiltered by the coarse-pore UF membrane 205 is circulated through the double-sided first drain 203 (reaction chamber) in accordance with a flow direction 217 of the reactive substances. FIG. 2 shows only a detail of the membrane-reactive device 201, so the circulatory connection for the flow through the double-sided first drain 203 is not shown in FIG. 2.

A feed chamber 221 having a first agitator 223 and a second agitator 225 is arranged on an untreated liquid side of the coarse-pore UF membrane 205. The first agitator 223 and the second agitator 225 cause untreated water in the feed chamber 221 to flow from outside in an optimal manner to the coarse-pore UF membrane 205, and particles retained in the feed chamber 221 by the coarse-pore UF membrane 205 are prevented from accumulating in front of the coarse-pore UF membrane 205 and leading to an undesired cake formation by the particles. The untreated liquid 211 prefiltered by the coarse-pore UF membrane 205 enters the first drain 203 (reaction chamber) where it comes into contact with the reactive substances (not shown), the ultra-fine powdered activated carbon particles as reactive substances reacting with the micropollutants contained in the prefiltered untreated liquid. The reactive substances loaded with the micropollutants are circulated through the first drain 203 in accordance with the flow direction 217 of the reactive substances. A transmembrane pressure of approximately 6 bar across the fine-pore UF membrane 207 causes the prefiltered untreated liquid 211 in the first drain 203 to pass through this fine-pore UF membrane 207 into the second drain 227 (permeate chamber), and it leaves the second drain 227 from both ends as a permeate stream 213. The fine-pore UF membrane 207 has a pore size corresponding to 15 kDa, so the ultra-fine powdered activated carbon particles as reactive substances are unable to pass through the fine-pore UF membrane 207 but instead remain in the first drain 203 and hence in circulation.

The membrane-reactive device 201 thus provides a double-membrane system having different pore sizes and dual filtration, with an integrated, intermediate reaction chamber for the removal of micropollutants by way of reactive substances. Thus, both a two-stage filtration and a further purification to remove micropollutants are achieved in a single treatment stage.

In one alternative, the membrane-reactive device is designed as a membrane-reactive modular tubular reactor 301. The inside of the membrane-reactive modular tubular reactor 301 comprises a plurality of tubular membranes 306 (three tubular membranes 306 are shown purely schematically in FIG. 3). Inside each tubular membrane 306 is a tube 302 with a surrounding UF membrane 305. The UF membrane 305 is surrounded by a UF drain 303, which forms the reaction chamber. The UF drain 303 is in turn surrounded by the NF membrane 307, which is closed off from the NF drain 327 on the outside. Thus, untreated water flows through each tubular membrane 306 from the inside to the outside.

In the upper part of the membrane-reactive modular tubular reactor 301, the tubes 302 are cast in a cast plane 335 of the UF. Similarly, a second, lower cast plane 335 surrounds the tubes 302 in the lower part of the membrane-reactive modular tubular reactor 301. In this way, an untreated liquid stream is only able to flow through the interior of the respective tube 302 via a surrounding feed intake 309 at the top of the membrane-reactive modular tubular reactor 301 since a surrounding wall of the membrane-reactive modular tubular reactor 301 together with the cast plane 335 of the UF form a feed chamber 321 on the inside. The untreated liquid passes from inside out of the tubes 302 through the surrounding UF membrane 305 and as a prefiltered untreated liquid 311 thus enters a chamber which is formed by the lower side of the cast plane 335 of the UF and the upper side of an upper cast plane 337 of the NF, and in the UF drain 303 it comes into contact with the reactive substances which are pumped into the membrane-reactive modular tubular reactor 301 via the inflow 331. Owing to the upper cast plane 337 of the NF, the mixture consisting of prefiltered untreated liquid 311 and the reactive substances is only able to flow in a flow direction 317 in a longitudinal direction of the UF drain 303, undergoing a reaction in the process. The reactive substances are held back by the NF membrane 307 and leave a chamber that is formed between a lower side of the lower cast plane 335 of the UF and an upper side of a lower cast plane 337 of the NF via a reactive substance outflow 333 in the membrane-reactive modular tubular reactor 301.

On the lower side, after the lower cast plane 335 of the UF, the untreated liquid leaves the membrane-reactive modular tubular reactor 301 via a feed outflow 310. The prefiltered untreated liquid 311 is filtered further by the NF membrane 307 and a permeate that is formed passes through the NF drain 327 into the permeate chamber 329 between the upper and lower cast plane 337 of the NF and is discharged via a permeate flow 313.

In a further alternative, the membrane-reactive device is designed as a membrane-reactive parallel flat-sheet module 401 (FIG. 5 shows two parallel flat-sheet modules one on top of the other). In this case, an NF drain 427 on the inside is surrounded by an NF membrane 407 and the NF membrane 407 is in turn surrounded by a UF drain 403 as the reaction chamber and on the outside by the UF membrane 405, forming a flat-sheet module through which untreated liquid flows from the outside to the inside. The ends of the NF membrane 407 are cast in a cast plane 437 of the NF and the respective NF drain 427 is connected to a permeate outflow 413. On the opposite side, the UF drain 403 is connected to a reactive substance inflow 431 and the ends of the UF membrane 405 are cast in a cast plane 435 of the UF. The individual flat-sheet modules are separated by spacers 441, flow channels for the feed inflow and outflow being formed between the spacers 441.

The membrane-reactive parallel flat-sheet module 401 is surrounded by a cast ring 439 (see FIG. 6) in which a feed intake 409 and a feed outflow 410 are embedded. The inflow 431 of the reactive substances takes place at the end via tubes leading into the UF drain 405 and the outflow 433 of the reactive substances likewise takes place at the end in the region of the cast plane 435 on the basis of an appropriate flow control along the respective flat-sheet membrane. At the opposite end, in the region of the cast plane 437 of the NF, a plurality of tubes for the permeate outflow 413 are arranged. The membrane filtration by way of the UF membrane 405, the reaction with the reactive substances in the UF drain 403 and the additional fine filtration by way of the NF membrane 407 take place in the same way as described above.

In a further alternative, the membrane-reactive device is designed as a membrane-reactive pressurized tube (spiral-wound module) 501. The membrane-reactive pressurized tube 501 has a perforated central tube 545 in the middle. Each NF membrane 507 is designed as a membrane envelope supported by an inner permeate spacer 543, each permeate spacer 543 being fluidically connected to the perforated central tube 545. Each UF membrane 505 is likewise designed as a membrane envelope with an inner feed spacer 541, and they are arranged evenly around but not in contact with the central tube 545. The flow through each UF membrane 505 is from the inside to the outside. A reaction chamber spacer 547 is arranged on each side of each UF membrane 505 (see FIG. 7). The envelopes of the UF membranes 505 are cast at both ends in an upper cast plane 535 and a lower cast plane 537, and they pass through the upper cast plane 535 up to the feed intake 509 and down to the feed outflow 510, the envelopes of the UF membranes 505 being open at these two ends. The envelopes of the NF membranes 507 are sealed all round and are fixed at the ends in the upper cast plane 535 and the lower cast plane 537 (see FIG. 8).

The untreated water enters the membrane-reactive pressurized tube 501 via a feed intake 509, flows through the respective feed spacers 541 and is prefiltered by UF membranes 505. In a chamber between the upper cast plane 535 and the lower cast plane 537, the prefiltered untreated water 511 comes into contact with the reactive substances which are supplied to the membrane-reactive pressurized tube 501 via the inflow 531 and leave it again via the outflow 533. The reactive substances are held back as described above by the NF membranes 507, while the permeate passes through the NF membranes 507 and flows through the permeate spacers 543 into the perforated central tube 545, from where the permeate leaves the membrane-reactive pressurized tube 501 via the permeate flow 513 on either side of the central tube 545. The two-stage filtration and the reaction with the reactive substances take place in the same way as described above.

In a further alternative of the membrane-reactive pressurized tube 601 in the form of a spiral-wound module, each NF membrane 607 in the form of a membrane envelope with inner permeate spacers 643 is likewise arranged directly at a perforated central tube 645. In this case, however, the membrane envelope of the NF membrane 607 is completely enclosed by a UF membrane 605 with reaction chamber spacers 647 interposed therebetween (FIG. 9). The membrane envelopes of the outer UF membranes 605 are separated from one another by feed spacers 641 arranged between them.

The UF membrane 605 together with the reaction chamber spacers 647 passes through both an upper cast plane 635 and a lower cast plane 537 (FIG. 10). Correspondingly, the UF membrane 605 is open at these ends above the upper cast plane 635 and below the lower cast plane 637, such that reactive substances flow through the inflow 631 into the inner chamber between UF membrane 605 and NF membrane 607 supported by the reaction chamber spacer 647 and flow out of the membrane-reactive pressurized tube 601 via an outflow 633 for the reactive substances. The membrane envelopes of each NF membrane 607, which are closed on all sides, are cast in the upper cast plane 635 and the lower cast plane 637 and are thus fixed in place.

In this embodiment, the untreated water containing micropollutants enters the membrane-reactive pressurized tube 601 from the side via a feed intake 609 and meets the outer side of the UF membrane 605. The flow through each UF membrane 605 is thus from the outside to the inside, and the prefiltered untreated water is contained in the chamber between the UF membrane 605 and the NF membrane 607 supported by the reaction chamber spacers 647, to which chamber the reactive substances are supplied as described above. From this chamber between the UF membrane 605 and the NF membrane 607, the permeate passes through the inner NF membrane 607 and is discharged via the permeate spacers 634 to the perforated central tube 645 and through both ends thereof to the permeate flow 613, while the reactive substances loaded with micropollutants leave the membrane-reactive pressurized tube 601 via the outflow 633. The two-stage filtration and the reaction with the reactive substances take place here in the same way as described above.

### LIST OF REFERENCE CHARACTERS

101 Membrane-reactive device
103 Reaction chamber
105 Coarse-pore UF membrane
107 Fine-pore UF membrane
109 Untreated liquid stream
111 Prefiltered untreated water
113 Filtrate stream
115 Reactive substances
117 Flow direction of reactive substances
119 Micropollutants
201 Membrane-reactive device
203 First drain (reaction chamber)
205 Coarse-pore UF membrane
207 Fine-pore UF membrane
211 Prefiltered untreated liquid
213 Permeate stream
217 Flow direction of reactive substances
221 Feed chamber
223 First agitator
225 Second agitator
227 Second drain (permeate chamber)
301 Membrane-reactive modular tubular reactor
302 Tube
303 UF drain (reaction chamber)
305 UF membrane
307 NF membrane
306 Tubular membrane
309 Feed intake (untreated water stream)
310 Feed outflow
311 Prefiltered untreated liquid
313 Permeate outflow
317 Flow direction of reactive substances
321 Feed chamber
327 NF drain
329 Permeate chamber
331 Inflow of reactive substances
333 Outflow of reactive substances
335 UF cast plane
337 NF cast plane
401 Membrane-reactive parallel flat-sheet module
403 UF drain (reaction chamber)
405 UF membrane
407 NF membrane
409 Feed intake (untreated water stream)
410 Feed outflow
413 Permeate outflow
427 NF drain
431 Inflow of reactive substances
433 Outflow of reactive substances
435 UF cast plane
437 NF cast plane
439 Cast ring
441 Spacer
501 Membrane-reactive pressurized tube
505 UF membrane
507 NF membrane
509 Feed intake (untreated water stream)
510 Feed outflow
511 Prefiltered untreated water
513 Permeate outflow
531 Inflow of reactive substances
533 Outflow of reactive substances
535 Cast plane
537 Cast plane
541 Feed spacer
543 Permeate spacer
545 Central tube
547 Reaction chamber spacer
601 Membrane-reactive pressurized tube
605 UF membrane
607 NF membrane
609 Feed intake (untreated water stream)
610 Feed outflow
613 Permeate outflow
631 Inflow of reactive substances
633 Outflow of reactive substances
635 Cast plane
637 Cast plane
641 Feed spacer
643 Permeate spacer
645 Central tube
647 Reaction chamber spacer

1. A device (101, 201, 301, 401, 501, 601) for membrane filtration and for the removal of micropollutants (119) from liquids by way of a reactive substance (115), the device comprising a reaction chamber (103, 203, 303, 403) and at least one port for supplying and/or discharging the reactive substance to and/or from the reaction chamber, such that the micropollutants are able to react with the reactive substance in the reaction chamber and/or may be removed from a liquid, and the reaction chamber comprising a first membrane (105, 205, 305, 405, 505, 605) and a second membrane (107, 207, 307, 407, 507, 607), wherein the first membrane (105, 205, 305, 405, 505, 605) is designed as an inlet into the reaction chamber and the second membrane (107, 207, 307, 407, 507, 607) is designed as an outlet from the reaction chamber, such that the liquid to be treated is able to be filtered by the first membrane and to flow into the reaction chamber (103, 203, 303, 403), the liquid treated with the reactive substance in the reaction chamber is able to be filtered by the second membrane and to flow out of the reaction chamber, and the outflow of treated liquid is substantially free from micropollutants.

2. The device as claimed in claim 1, wherein the second membrane has a smaller pore size than the first membrane, such that the reactive substance may be retained in the reaction chamber.

3. The device as claimed in claim 1, wherein the first membrane is arranged on one side of the reaction chamber and the second membrane is arranged on a side of the reaction chamber opposite that side.

4. The device as claimed in claim 1, wherein the device is set up in such a way that a flow direction (117, 217, 317) of the reactive substance is substantially at right angles to an inflow and/or outflow direction of the liquid through the first and/or second membrane.

5. The device as claimed in claim 1, wherein the first membrane and/or the second membrane is or are a submerged membrane.

6. The device as claimed in claim 1, wherein the first membrane and/or the second membrane is or are a microfiltration membrane, an ultrafiltration membrane (205, 207, 305, 405, 505, 605) and/or a nanofiltration membrane (307, 407, 507, 607).

7. The device as claimed in claim 1, wherein the reaction chamber is designed and/or is operable as a batch reactor and/or as a continuous-flow reactor.

8. The device as claimed in claim 1, wherein the device has a regeneration unit for regenerating consumed reactive substance or a regeneration unit is associated with the device.

9. The device as claimed in claim 1, wherein the device contains a reactive substance or a plurality of reactive substances, wherein the reactive substance or plurality of reactive substances is or are a dissolved, emulsified, dispersed, suspended and/or solid substance.

10. The device as claimed in claim 9, wherein the reactive substance or the reactive substances is or are an oxidant, absorbent, precipitant, coagulant, flocculant, ion exchanger, catalyst and/or biogenic sub stance.

11. The device as claimed in claim 5, wherein the submerged membrane is a flat-sheet membrane, a spiral-wound membrane, and/or a pressurized tubular membrane.
